(19) United States
(12) Patent Application Publication
(10) Pub. No.: US 2012/0055076 A1
(43) Pub. Date: Mar. 8, 2012

(54) SYSTEMS AND METHODS FOR PEST CONTROL

(76) Inventors: Michelle S. Smith, Carmel, IN (US); Mike P. Tolley, Indianapolis, IN (US); Joe J. DeMark, Fayetteville, AR (US); Chris Voglewede, Lafayette, IN (US); Donald E. Williams, III, Greenfield, IN (US); Mike Melichar, Zionsville, IN (US)

(21) Appl. No.: 13/223,664

(22) Filed: Sep. 1, 2011

Related U.S. Application Data
(60) Provisional application No. 61/380,958, filed on Sep. 8, 2010.

(51) Int. Cl. A01M 1/20; A01M 25/00; A01N 43/54; A01P 7/04; A01N 47/34; A01N 41/06

(52) U.S. Cl. 43/131; 514/594; 514/601; 514/275

(57) ABSTRACT

Systems and methods for controlling one or more types of pests include the use of one or more freestanding pesticidal baits positioned at a location below and/or adjacent to one or more foundation elements of a building structure. In one form, the pesticidal baits are formed by a compressed mixture of a pesticide and a bait material that is palatable to one or more types of pests. In another form however, the pesticidal baits are formed by an extruded mixture of a pesticide and a bait material that is palatable to one or more types of pests. In a further aspect of these forms, the bait material is palatable to one or more wood-destroying pest species such as termites. However, other embodiments, forms and applications are also envisioned.

### CROSS-REFERENCE TO RELATED APPLICATIONS

The present application claims priority to U.S. Provisional Patent Application No. 61/380,958 filed Sep. 8, 2010, the content of which is incorporated herein by reference in its entirety.

### BACKGROUND

The protection of wooden structures from damage caused by pests has been an area of particular interest for many years, and the removal of pests from areas occupied by humans, livestock, and crops has long been a challenge. Pests of frequent concern include various types of insects and rodents. Subterranean termites are a particularly troublesome type of pest with the potential to cause severe damage to wooden structures. Various schemes have been proposed to eliminate termites and certain other harmful pests of both the insect and noninsect variety. In one approach, pest control relies on the blanket application of liquid pesticides in the area to be protected. In some instances, the liquid pesticides can be carried away from their site of application by rain or other surface water, giving rise to potential environmental concerns. In another approach, a system includes a number of units each housing a termite edible material and placed at least partially in the ground about a dwelling to be protected. The units are inspected routinely by a pest control service for the presence of termites. If termites are found in a given unit, a bait is installed that contains a slow-acting pesticide intended to be carried back to the termite nest to eradicate the colony. An example of this type of system is the SENTRICON® Termite Colony Elimination System of Dow AgroSciences LLC that has a business address of 9330 Zionsville Road, Indianapolis, Ind.

There is a continuing demand for further advancement in the areas of pest control and related technologies, and the development of new techniques for more reliably and/or cost-effectively preventing damage to wooden structures and eradicating termites or other pests is desired.

### SUMMARY

The present application is generally directed to systems and methods for controlling one or more types of pests. In one form, these systems and methods involve the use of one or more freestanding pesticidal baits positioned at a location below and/or adjacent to one or more foundation elements of a building structure. Still, in another form, the systems and methods disclosed herein contemplate the use of one or more pesticidal baits positioned at one or more other locations of a building site. In one form, the pesticidal baits are defined by a compressed mixture of a pesticide and a bait material that is palatable to one or more types of pests. In another form, the pesticidal baits are defined by an extruded mixture of a pesticide and a bait material that is palatable to one or more types of pests. In certain forms, use of compressed and extruded baits together is contemplated. In a further aspect of these forms, the bait material is palatable to one or more wood-destroying pest species such as termites.

In one embodiment, a method includes providing at least one bait that includes a bait material and a pesticide. The method also includes positioning the at least one bait at a location to lie underneath a foundation element of a building structure. In one aspect of this form, positioning the at least one bait is performed before excavation of the location for placement of the foundation element but before placement of the foundation element. In another aspect, the bait is defined by a compressed or extruded mixture of the bait material and pesticide. In certain aspects, the providing and positioning steps are performed by a single entity or individual. For example, in one form a construction company or a pest control provider can provide the baits at the site of the building structure and then position the baits as specified above. However, it should also be appreciated that forms where these steps are performed by more than one entity or individual are also contemplated. For example, in one form a manufacturer, wholesaler, distributor or other seller of the baits can provide the baits and then another entity, such as a construction company or a pest service provider, can position the baits.

In another embodiment, a method includes positioning a first freestanding pesticidal bait at one or more of a first location to lie underneath a lower terminus of a building foundation and a second location below ground level and proximate to the foundation. In one aspect of this embodiment, the method further includes positioning a second pesticidal bait proximate to the foundation below ground level and at a depth less than the first pesticidal bait.

In another embodiment, a system for controlling pests includes a plurality of freestanding pesticidal baits positioned at one or more locations of a building site. The one or more locations include at least one of one or more first positions under one or more foundation elements of a building structure and one or more second positions adjacent to the one or more foundation elements and below final or finish grade of the building site. In one aspect of this embodiment, the one or more locations include one or more of the first positions and one or more of the second positions.

In yet another embodiment, a method includes positioning a first pesticidal bait at a first depth below ground level proximate to a building foundation; covering the first pesticidal bait with a first portion of fill material; positioning a second pesticidal bait at a second depth below the ground level proximate to a building foundation, the first depth being greater than the second depth relative to the ground level; covering the second pesticidal bait with a second portion of fill material; positioning a third pesticidal bait at a third depth below the ground level proximate to a building foundation, the second depth being greater than the third depth relative to the ground level; and covering the third pesticidal bait with a third portion of fill material.

In still another embodiment, a method includes installing at least one bait including a bait material palatable to one or more species of pest and a pesticide relative to a foundation of a building structure. The method also includes, during the installing, positioning the at least one bait at a location to lie underneath an element of the foundation. In one aspect of this form, positioning the at least one bait is performed after excavation of the location for placement of the foundation element but before placement of the foundation element. In another aspect, the bait is defined by a compressed or extruded mixture of the bait material and pesticide.

In yet another embodiment, a method includes positioning at least one bait at a location to lie underneath a foundation element of a building structure. The at least one bait includes a bait material palatable to one or more species of pest and a pesticide.

Another embodiment of the present application is a unique technique for controlling and/or preventing pests. Other embodiments include unique methods, systems, devices, kits, assemblies, equipment, and/or apparatus involving pest control and/or pest prevention techniques.

Further embodiments, forms, features, aspects, benefits, objects and advantages of the present application shall become apparent from the detailed description and figures provided herewith.

### BRIEF DESCRIPTION OF THE DRAWINGS

FIG. 1 is a diagrammatic view of one embodiment pest control system relative to a foundation of a building structure.

FIG. 2 is a diagrammatic view of an alternative embodiment pest control system relative to an alternatively arranged foundation of a building structure.

FIG. 3 is a diagrammatic view of another alternative embodiment pest control system relative to another alternatively arranged foundation of a building structure.

FIG. 4 is a perspective view of one form for a pesticidal bait.

FIG. 5 is a perspective view of an alternative form for a pesticidal bait.

FIG. 6 is a perspective view of another alternative form for a pesticidal bait.

FIG. 7 is a graph comparing compression density and pressure data from the experiment described in Example I.

FIGS. 8 and 9 are bar graphs depicting durability and mold ratings from the experiment described in Example II.

FIG. 10 is a diagrammatic view of a testing apparatus used in the experiment described in Example III.

FIG. 11 is a diagrammatic view of a testing apparatus used in the experiment described in Example IV.

FIG. 12 is a schematic illustration of a treatment grid used in the experiment described in Example V.

### DETAILED DESCRIPTION OF SELECTED EMBODIMENTS

For the purposes of promoting an understanding of the principles of the inventions described herein, reference will now be made to the embodiments illustrated in the drawings and specific language will be used to describe the same. It will nevertheless be understood that no limitation of the scope of any invention is thereby intended. Any alterations and further modifications in the illustrated embodiments, and any further applications of the principles described and illustrated herein are contemplated as would normally occur to one skilled in the art.

Systems and methods for controlling one or more species of pests involve at least one pesticidal bait positioned under and/or around one or more features of a building structure. The pesticidal bait includes a bait material that is palatable to the one or more species of pests and a pesticide that is toxic to the one or more species of pests. In one form, the pesticidal bait is defined by a composite material that includes the bait material and the pesticide. In one specific aspect, the pesticidal bait is used to control the presence of at least one species of wood-destroying pests. The term “wood-destroying pest” is used herein to refer to an insect or other pest that destroys the structural integrity of wood by boring into wood or consuming wood. Examples include, without limitation, termites, carpenter ants, carpenter wasps and other wood boring or cellulose consuming organisms. Still, use of the pesticidal bait to control non-wood-destroying pests is also contemplated.

In one form, the pesticidal bait is formed by a compressed mixture of the bait material and pesticide. In one aspect, the compressed form of the pesticidal bait is configured to provide sufficient strength and structural integrity for a desired end use of the pesticidal bait. The pesticide retains its bioactivity as it resides within the compressed form, and produces a desired result after the pesticidal bait is ingested by or otherwise comes into contact with pests. In another more particular aspect, the compressed form of the pesticidal bait is configured to break apart or disintegrate over time and/or upon exposure to moisture. Moreover, the bait material may be defined by a material or mixture of materials that readily biodegrade and/or dissolve into the soil or other medium where each respective pesticidal bait is positioned. Following disintegration of the compressed bait and/or biodegradation/dissolution of the bait material, the pesticide retains its bioactivity and creates an effective barrier in the soil or other medium surrounding the original pesticidal bait in order to provide long-term control of the one or more species of pest even after the original pesticidal bait structure is no longer present.

In another form however, the pesticidal bait is provided in a form that is moisture and degradation resistant and exhibits long-term durability and integrity. Similarly, in this form, it is contemplated that the pesticidal bait will generally not break apart following placement in soil or other media. While not being limited to any particular configuration, in one aspect of this form the pesticidal bait is formed by an extruded mixture of the bait and pesticide. In a more particular aspect of this form, the extruded mixture also includes a thermoplastic polymer material which, while not being limited to any particular configuration, can increase the moisture and disintegration resistance of the pesticidal bait. Further details regarding non-limiting examples of extruded pesticidal baits are found in International Patent Publication No. WO 2008/079384, the contents of which are incorporated herein by reference in their entirety. In addition, it should be appreciated that the use of one or more moisture and degradation resistant pesticidal baits in combination with one or more pesticidal baits configured to break apart or disintegrate over time and/or upon exposure to moisture is also contemplated.

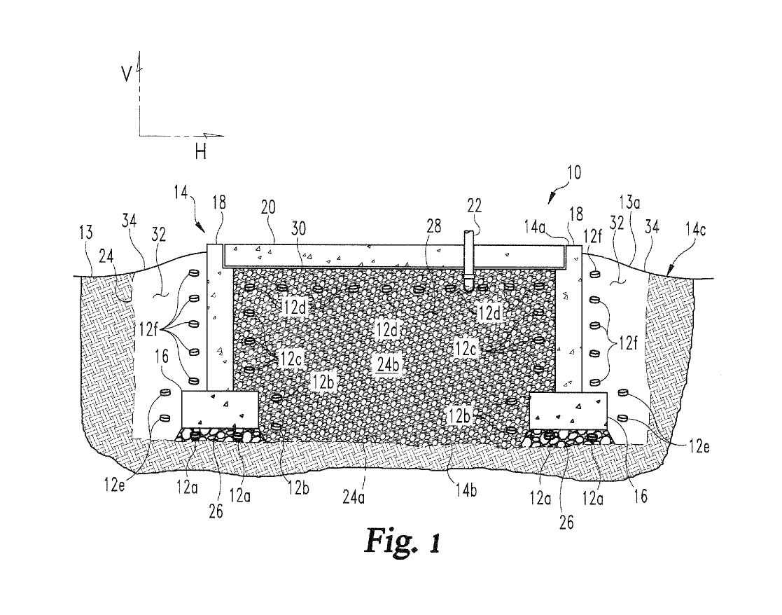

As indicated above, various systems and methods involve the use of one or more of the above-described pesticidal baits at positions under and/or around one or more features of a building structure. More particularly, with reference to FIG. 1 for example, a system 10 includes a plurality of pesticidal baits 12a-f (collectively baits 12) that are placed under and around one or more features of foundation 14, which in the illustrated embodiment is in the form of a supported slab 20. However, it should be understood that system 10 may be implemented with other types of foundations and building structures as well. The upper terminus of foundation 14 is designated by reference numeral 14a and the lower terminus of foundation 14 is designated by reference numeral 14b. Foundation 14 includes footings 16 on which walls 18 are positioned. Slab 20 of foundation 14 extends between and is supported by walls 18, and a mechanical component 22, such as a plumbing, electrical or HVAC component, extends through slab 20 and, while not illustrated, may also extend through one or both of walls 18. In one form, footings 16, walls 18 and slab 20 are formed by concrete, although in other forms the use of one or more different materials for one or more of footings 16, walls 18 and slab 20 is contemplated. In addition, while not illustrated it should be appreciated that additional structure, such as wood or metal framing for example, can be positioned on and extend from walls 18 and/or slab 20.

In one non-limiting approach for placing foundation 14, a building site 14c is initially surveyed to determine where foundation 14 should be placed. Once the position of foundation 14 is determined, the building site 14c may be excavated to remove loose topsoil, sand or vegetation for example, such that footings 16 of foundation 14 will be placed on solid ground. Additionally or alternatively, the building site 14c may be excavated such that the elevation of the finished building structure corresponds to a required or planned elevation. In one or more forms where site excavation is not necessary, it is contemplated that footings 16 may be placed directly on top of the existing land at the building site 14c. However, when required, site excavation can include the localized removal of ground at areas surroundings footings 16 and or walls 18 only, or it may involve the removal of ground below the entire footprint of the building structure to be constructed at the building site. In the exemplary embodiment illustrated in FIG. 1, site excavation includes the formation of a foundation hole 24 shown in phantom. Hole 24 is slightly larger than the footprint of foundation 14 or, stated alternatively, includes areas of over-dig. As appreciated by those skilled in the art, this arrangement provides additional room which may facilitate placement of various elements of foundation 14.

Baits 12 are positioned below ground level 13 with some being at different depths relative to each other and ground level 13. In the illustrated embodiment, pesticidal baits 12a are the deepest, being positioned in granular fill 26 above or on the surface 24a defined by the bottom (lower) boundary or margin of hole 24. Accordingly, granular fill 26 covers/surrounds baits 12a in the depicted embodiment such that baits 12a are, in effect, suspended in fill 26. Granular fill 26 may be of the type commonly used to support footings 16 and/or other elements of foundation 14. Further, as used herein, “fill” broadly refers to any construction material used to underlie a foundation member, backfill a foundation, or otherwise fill a void about a foundation, including without limitation, gravel, soil, sand, earth, and rock, among other possibilities. Footings 16 are positioned above pesticidal baits 12a and granular fill 26. In other approaches, pesticidal baits 12a may be positioned to directly contact surface 24a with granular fill 26 thereabove; or granular fill 26 between footings 16 and surface 24a may be absent, such that footings 16 rest directly on surface 24a and pesticidal baits 12a are at least partially positioned in footings 16 and/or submerged in surface 24a below footings 16. Still, in other forms, footings 16 may be positioned on the surface 24a without any pesticidal baits 12a positioned thereunder. When pesticidal baits 12a are present however, it should be understood that they can be positioned in an arrangement that extends below the entire extent of footings 16. Nonetheless, forms in which pesticidal baits 12a are only positioned below a portion or portions of footings 16 are also possible.

Once footings 16 are placed, walls 18 may be positioned thereon, although other variations in the order of placing footings 16 and walls 18 are contemplated. For example, in one form, it is contemplated that footings 16 and walls 18 are integral and positioned in hole 24 at the same time. In the illustrated form, the interior space 24b situated between footings 16 and walls 18 is filled with granular fill 28. However, in other forms where excavation of the building site 14c only involves localized removal of ground at areas surrounding footings 16 and/or walls 18, it is contemplated that at least part of the space between footings 16 and walls 18 may include undisturbed ground of the building site 14c. In either case, granular fill 28 is positioned adjacent to footings 16 and walls 18 to fill any areas of over-dig around footings 16 and walls 18 and/or the interior space 24b between footings 16 and walls 18. As granular fill 28 is being added, pesticidal baits 12b are intermittently positioned adjacent to footings 16 in the interior space 24b defined therebetween by hole 24 such that pesticidal baits 12b are positioned in and spaced apart by granular fill 28. In one form, pesticidal baits 12b are provided in an arrangement that extends along the entire interior perimeter defined by footings 16, although forms in which pesticidal baits 12b are only positioned along a portion or portions of the interior perimeter defined by footings 16 are also possible.

In addition, also while granular fill 28 is being added, pesticidal baits 12c are intermittently positioned adjacent to walls 18 in the interior space 24b such that pesticidal baits 12c are positioned in and spaced apart by granular fill 28. Pesticidal baits 12e may be provided in an arrangement that extends along the entire interior perimeter defined by walls 18, although forms in which pesticidal baits 12c are only positioned along a portion or portions of the interior perimeter defined by walls 18 are also possible. Pesticidal baits 12d are positioned in the interior space 24b between walls 18 near the top of walls 18 and below slab 20. In the illustrated form, pesticidal baits 12d are positioned in granular fill 28 and, rather than being positioned only adjacent to footings 16 and walls 18 as illustrated with respect to pesticidal baits 12b and 12c, respectively, are spaced out in an arrangement that laterally extends along horizontal axis H between walls 18. In certain non-illustrated forms, one or more of pesticidal baits 12b and 12c may be spaced in an arrangement that extends along horizontal axis H between footings 16 and/or walls 18. Pesticidal baits 12d may be provided in an arrangement that extends across the entire surface covered by slab 20, although forms in which pesticidal baits 12d are provided in an arrangement that only extends across a portion or portions of the surface covered by slab 20 are possible.

It should be further understood that forms in which one or more of pesticidal baits 12d is positioned directly on undisturbed ground between walls 18 instead of in granular fill 28 are also possible. In addition, in the illustrated form pesticidal baits 12d are positioned in close proximity to and on opposite sides of component 22, although other variations, including those in which pesticidal baits 12d surround component 22, are contemplated. Additional granular fill 28 is then positioned over pesticidal baits 12d to an appropriate level and a vapor barrier 30 is positioned over granular fill 28. However, in alternative forms, it is contemplated that vapor barrier 30 may be omitted or that pesticidal baits 12d are positioned at the top of granular fill 28 such that no additional fill 28 is positioned thereover. Collectively, it should be appreciated that at least some of pesticidal baits 12b, 12c, and 12d are vertically spaced apart from other of pesticidal baits 12b, 12c, and 12d relative to vertical axis V, and correspondingly are positioned at different depths below ground level 13. Once the appropriate level of granular fill 28 is achieved and vapor barrier 30, if present, has been laid out, foundation 14 is provided with slab 20 which, in the illustrated form, is positioned on a portion of and between walls 18.

While not previously discussed, it should be appreciated that the exterior space around footings 16 and walls 18 may be filled in simultaneously with, before, or after filling the interior space 24b between footings 16 and walls 18 and/or positioning of slab 20. However, as fill 32, which may be soil or any other type of suitable fill, is positioned against footings 16, a plurality of pesticidal baits 12e are intermittently positioned adjacent to footings 16 such that pesticidal baits 12e are positioned in and vertically spaced apart from one another by fill 32. In addition, as fill 32 is positioned against walls 18, a plurality of pesticidal baits 12f are intermittently positioned adjacent to walls 18 such that pesticidal baits 12f are also positioned in a vertically spaced apart relationship along wall 18 with fill 32 positioned therebetween, such that at least some of baits 12f are positioned at different depths relative to other of baits 12f below ground level 13. The uppermost one of pesticidal baits 12f is positioned near the top of walls 18 and below finish grade 34 of the building site 14c, which in the illustrated form slopes away from the top of walls 18, partly defining ground level 13 as its upper margin or boundary 13a. However, other variations in finish grade 34 are contemplated. Pesticidal baits 12e and 12f may be provided in an arrangement that extends along the entire exterior perimeter defined by footings 16 and walls 18, respectively, although forms in which pesticidal baits 12e and 12f are only positioned along a portion or portions of the exterior perimeter defined by footings 16 and walls 18 are also possible.

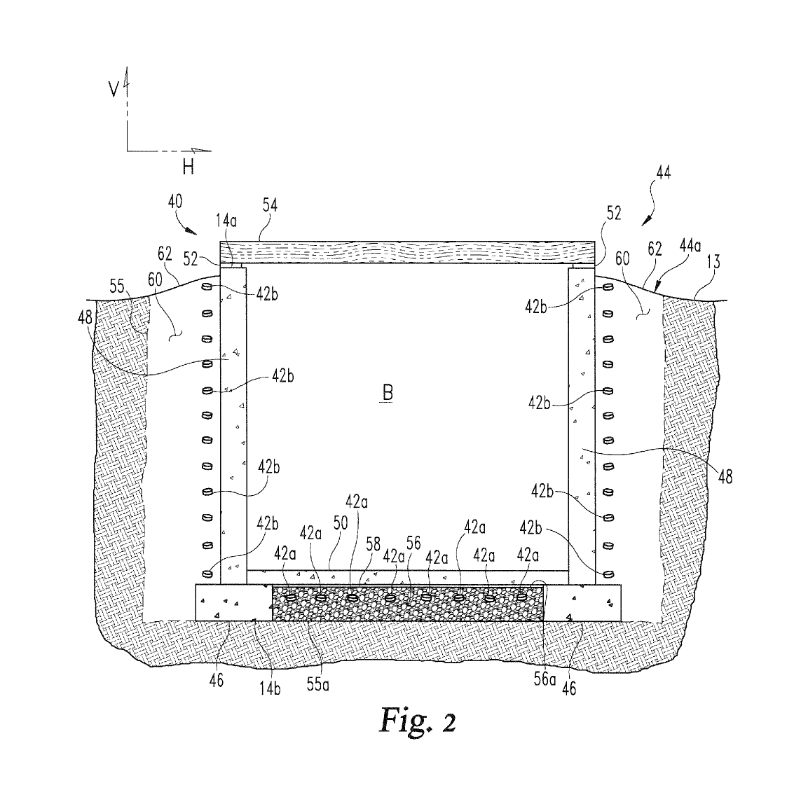

An alternative embodiment system 40 is diagrammatically illustrated in FIG. 2; where like reference numerals refer to like features previously described. System 40 includes a plurality of pesticidal baits 42a-b (collectively baits 42) that are placed under and around one or more features of foundation 44, which in the illustrated embodiment is in the form of a subterranean basement B. In other forms, it should be appreciated that foundation 44 may be in the form of a daylight or walkout basement, just to provide a few examples. Foundation 44 includes footings 46 on which walls 48 are positioned. A slab 50 extends between walls 48 and is partially positioned over footings 46. While not illustrated, it should be appreciated that a mechanical component similar to component 22 can extend through slab 50 and/or one or both of walls 48. In one form, footings 46, walls 48 and slab 50 are formed by concrete, although other forms contemplate the use of one or more different materials for one or more of footings 46, walls 48 and slab 50. Sill plates 52 are positioned on top of walls 48 and a plurality of joists 54 are positioned on top of plates 52. In addition, while not illustrated, it should be appreciated that additional structure, such as wood or metal framing for example, can be positioned on and extend from joists 54.

In one non-limiting approach for placing foundation 44, building site 44a is initially surveyed to determine the location of foundation 44. Once the location of foundation 44 is determined, building site 44a is excavated to provide an excavation hole 55 in which at least a portion of foundation 44 will be positioned. Hole 55 is slightly larger than the footprint of foundation 44 or, stated alternatively, includes areas of over-dig. As would be understood by those skilled in the art, this arrangement leaves additional room which can facilitate placement of various elements of foundation 44. Once hole 55 has been appropriately excavated, footings 46 can be placed on or over surface 55a defined by the bottom margin/border of hole 55. While not illustrated in FIG. 2, it should be understood that granular fill and/or one or more pesticidal baits 42 may be positioned under footings 46 in an approach similar to that described above with regard to the positioning of pesticidal baits 12a in system 10.

In one approach, walls 48 are placed on footings 46 followed by placement of slab 50 therebetween. However, alternative approaches regarding the placement order of the features of foundation 44 are contemplated. In any event, before placement of slab 50, pesticidal baits 42a are positioned on or over surface 55a. In one form, pesticidal baits 42a can be systematically or randomly positioned throughout the entire area over which slab 50 shall lie, although forms in which pesticidal baits 42a are systematically or randomly positioned only throughout a portion or portions of the area over which slab 50 will lie are also possible. In another form, pesticidal baits 42a may only be positioned proximate to the interior perimeter of the area defined by footings 46. Granular fill 56 is then added over pesticidal baits 42a and/or granular fill 56 may be applied below some or all of pesticidal baits 42a before pesticidal baits 42a are positioned in hole 55. As depicted, pesticidal baits 42a are covered with fill 56 followed by placement of vapor barrier 58 thereover. Pesticidal baits 42a can be positioned near the top margin/border 56a of fill 56, and may be at least partly exposed and/or at least partially covered by fill 56. In one form, pesticidal baits 42a are in effect suspended in fill 56 between surface 55a and the top margin/border 56a. Vapor barrier 58 is positioned over fill 56 and pesticidal baits 42a; however, in other embodiments, it is contemplated that vapor barrier 58 may be omitted.

Other variations in the placement of pesticidal baits 42a are also contemplated. In one form for example, pesticidal baits 42a may additionally or alternatively be positioned to contact surface 55a of hole 55 followed by the addition of granular fill 56 thereover, and/or granular fill 56 may be absent such that slab 50 is directly positioned over pesticidal baits 42a. In other forms, one or more pesticidal baits 42a may be randomly interspersed at one or more levels of granular fill 56 with respect to vertical axis V between vapor harrier 58 and surface 55a, such that at least some of pesticidal baits 42a are at a different depth relative to at least some others of pesticidal baits 42a. Alternatively or additionally, it is contemplated that granular fill 56 may be added first followed by positioning of the pesticidal baits 42a on top of or in granular fill 56. Once the appropriate level of granular fill 56 is achieved and vapor barrier 58 (if present) has been laid out, slab 50 is placed between walls 48. In non-illustrated forms where a mechanical component extends through slab 50, it should be appreciated that baits 42a may be positioned in close proximity to, on opposite sides of, and/or surrounding the component as discussed above in connection with component 22.

As discussed above with respect to system 10, it is contemplated that the exterior space around footings 46 and walls 48 may be filled in before, during or after positioning of slab 20 and/or positioning of plates 52 and joists 54. However, as fill 60, which may be soil or any other type of suitable fill, is positioned against walls 48, a plurality of pesticidal baits 42b are intermittently positioned adjacent to walls 48 such that at least some of pesticidal baits 42b are vertically spaced apart from at least some other of pesticidal baits 42b by fill 60. In this arrangement, pesticidal baits 42b are distributed at different depths below ground level 13. The uppermost ones of pesticidal baits 42b are positioned near the top of walls 48 and below finish grade 62 of the building site 44a, which in the illustrated form slopes away from the top of walls 48 below plates 52. However, other variations in finish grade 62 are contemplated. The upper margin/boundary of finish grade 62 partly defines ground level 13. Pesticidal baits 42b may be provided in an arrangement that extends along the entire exterior perimeter defined by walls 48, although forms in which pesticidal baits 42b are only positioned along a portion or portions of the exterior perimeter defined by walls 48 are also possible. While not illustrated in FIG. 2, it should be understood that one or more pesticidal baits 42 may be intermittently positioned adjacent to the outside of footings 46 in an approach similar to that described above in connection with pesticidal baits 12e in system 10. In addition, if a mechanical component extends through one or both of walls 48, it is contemplated that one or more baits 42b can be positioned in close proximity to, on opposite sides of, and/or surrounding such mechanical component.

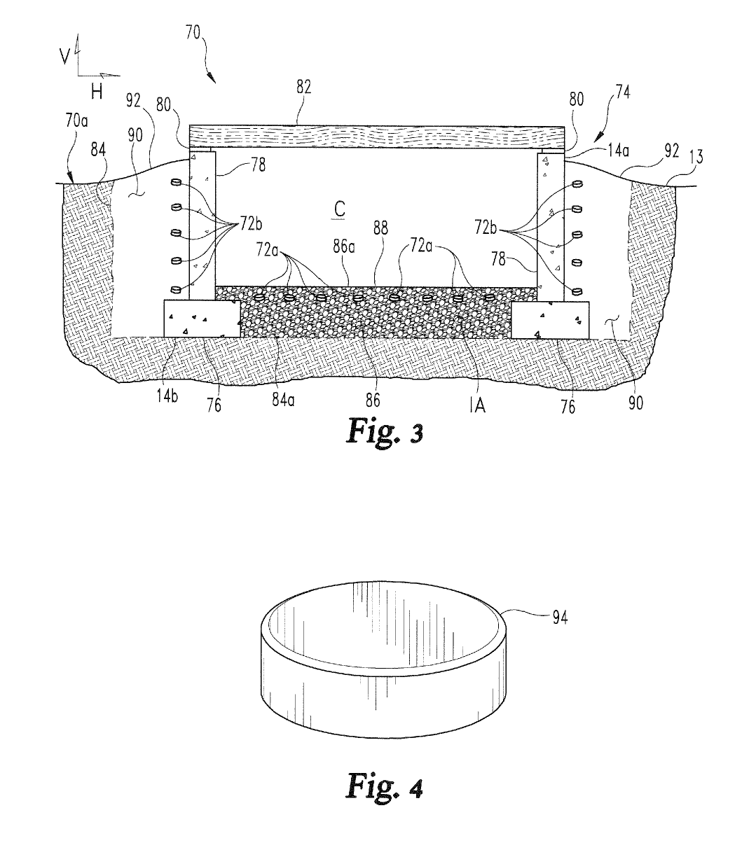

Another alternative embodiment system 70 is diagrammatically illustrated in FIG. 3; where like reference numerals refer to like features previously described. System 70 includes a plurality of pesticidal baits 72a-b (collectively baits 72) that are placed around one or more features of foundation 74, which in the illustrated embodiment is in the form of a crawlspace C. Foundation 74 includes footings 76 on which walls 78 are positioned. In one form, footings 76 and walls 78 are formed by concrete, although other forms contemplate the use of one or more different materials for one or both of footings 76 and walls 78. Sill plates 80 are positioned on top of walls 78 and a plurality of joists 82 are positioned on top of plates 80. In addition, while not illustrated it should be appreciated that additional structure, such as wood or metal framing for example, can be positioned on and extend from joists 82.

In one non-limiting approach for placing foundation 74, building site 70a is initially surveyed to determine the location of foundation 74. Once the location of foundation 74 is determined, building site 70a is excavated to provide an excavation hole 84 in which at least a portion of foundation 74 will be positioned. Hole 84 is slightly larger than the footprint of foundation 74 or, stated alternatively, includes areas of over-dig. As would be understood by those skilled in the art, this arrangement leaves additional room which can facilitate placement of various elements of foundation 74. Once hole 84 has been appropriately excavated, footings 76 can be placed over surface 84a defined by the bottom margin/border of hole 84. While not illustrated in FIG. 3, it should be understood that granular fill and/or one or more pesticidal baits 72 may be positioned under footings 76 in an approach similar to that described above in connection with positioning of pesticidal baits 12a in system 10. In other non-illustrated forms, a mechanical component similar to component 22 can extend through surface 84a between footings 76 and/or through one or both of walls 78.

In one approach, walls 78 are placed on footings 76 followed by positioning of fill 86 in the interior area IA between footings 76 and walls 78. However, alternative approaches regarding the placement order of the features of foundation 74 are contemplated. In any event, pesticidal baits 72a are positioned near the top of fill 86, and may be at least partly exposed and/or at least partially covered by fill 86. In one form, pesticidal baits 72a are in effect suspended in fill 86 between surface 84a and the top margin/border of fill 86 designated by reference numeral 86a. Pesticidal baits 72a can be systematically or randomly positioned throughout the entire area or one or more portions of the area between footings 76 and/or walls 78. Positioning of pesticidal baits 72a may also be limited to locations proximate to the perimeter of the interior area IA defined between footings 76 and/or walls 78. Vapor barrier 88 is positioned over fill 86 and pesticidal baits 72a; however, in other embodiments, it is contemplated that vapor barrier 88 may be omitted.

Other variations in the placement of pesticidal baits 72a are also contemplated. In one form for example, pesticidal baits 72a may additionally or alternatively be positioned to contact surface 84a of hole 84 followed by the addition of granular fill 86 thereover, and/or granular fill 86 may be absent. In other forms, one or more pesticidal baits 72a may be randomly interspersed at one or more levels of granular fill 86 with respect to vertical axis V between vapor barrier 88 and surface 84a, such that at least some of pesticidal baits 42a are at a different depth relative to at least some others of pesticidal baits 42a. Moreover, while not previously discussed, it should be appreciated that pesticidal baits 72a may be placed in the crawlspace C (including without limitation one or more pesticidal baits 72a resting on vapor barrier 88) at any time following the completion of foundation 74 or the building structure (not shown) on foundation 74.

As discussed above with respect to system 10, it is contemplated that the exterior space around footings 76 and walls 78 may be filled in before, during, or after the positioning of fill 86 and/or the positioning of plates 80 and joists 82. However, as fill 90, which may be soil or any other type of suitable fill, is positioned against walls 78, a plurality of pesticidal baits 72b are intermittently positioned adjacent to walls 78 such that pesticidal baits 72b are positioned in and spaced apart from one another by fill 90. As depicted, at least some of pesticidal baits 72b are vertically spaced apart from at least some other pesticidal baits 72b, such that they are at different depths below ground level 13. The uppermost ones of pesticidal baits 72b are positioned near the top of walls 78 and below finish grade 92 of the building site 70a, which in the illustrated form slopes away from the top of walls 78 below plates 80. However, other variations in finish grade 92 are contemplated. The upper margin/boundary of finish grade 92 partly defines ground level 13. Pesticidal baits 72b may be provided in an arrangement that extends along the entire exterior perimeter defined by walls 78, although forms in which pesticidal baits 72b are only positioned along a portion or portions of the exterior perimeter defined by walls 78 are also possible. While not illustrated in FIG. 3, it is contemplated that one or more pesticidal baits may be intermittently positioned adjacent to the outside of footings 76 in an approach similar to that described above in connection with pesticidal baits 12e in system 10. In addition, one or more of baits 72a and 72b can be positioned in close proximity to, on opposite sides of, and/or surrounding a mechanical component, when present, that extends through surface 84a between footing 76 and/or through one or both of walls 78.

Systems 10, 40, 70 and foundations 14, 44, 74 illustrated in FIGS. 1-3 are exemplary only, and it should be appreciated that the use of the pesticidal baits described herein could be implemented in connection with one or more alternatively arranged foundations, building sites, or the like, in accordance with one or more of the techniques disclosed herein or other similar techniques modified for use in connection with an alternative arrangement. In addition, while not illustrated, one or more additional features, such as drainage tiles or utility lines for example, can be associated with one or more of foundations 14, 44, 74. Furthermore, variations in the configuration of foundations 14, 44, 74 and/or finish grade 34, 62, 92 are possible. Similarly, in these alternatively configured arrangements, placement of the pesticidal baits 12, 42, 72 may also vary but will generally result in an effective barrier around foundations 14, 44, 74 against one or more species of pest, such as termites, as further described hereinafter.

Accordingly, certain aspects of the subject application involve placement of one or more pesticidal baits at one more locations during the construction of a building structure. More particularly, in one form, one or more pesticidal baits are positioned proximate to and/or under one or more foundation elements. These baits may be spaced apart and positioned relative to the underground portions of a building and each other to provide an effective barrier/perimeter to invasive underground pests, like termites. Non-limiting examples of foundation elements include footings, vertical walls, slab floors, piles, pilings, piers or beams, just to provide a few non-limiting examples. In addition, it should be appreciated that the foundation elements can be formed of any suitable material such as concrete. In other instances however, it is contemplated that one or more of the foundation elements could be formed from wood, metal, or a composite material amongst other possibilities. In one form, one or more of the pesticidal baits are positioned before placement of an adjacent foundation element, although in other forms one or more of the pesticidal baits are positioned following placement of one or more of the foundation elements. In another form, one or more of the pesticidal baits are placed at the building site as fill material is positioned around one or more of the foundation elements. In one aspect of this form, the pesticidal baits are step-wise placed with the fill material such that the pesticidal baits are separated by and positioned at various levels of the fill material. In this arrangement, the pesticidal baits are placed at different depths below ground level. The placement of one or more pesticidal baits during the construction of a building structure may generally provide a barrier that is effective in deterring or preventing one or more species of pest from approaching or entering a building structure positioned on the one or more foundation elements. Similarly, placement of the one or more pesticidal baits during the construction process pre-treats the building site and is intended to eliminate or delay any pest infestation in or around the building structure.

Notwithstanding the foregoing, it should be appreciated that variations in the timing of placement of the pesticidal baits under and/or around the features of foundations 14, 44, 74 or other foundations are also contemplated. For example, in one or more forms, it is contemplated that one or more of the pesticidal baits could be positioned above the ground level 12 at areas adjacent to foundations 14, 44, 74 after the finish grade 34, 62, 92 has been prepared. In other forms, it is contemplated that one or more of the pesticidal baits described herein could be added around and/or under the foundation of an existing building structure. In one aspect of this form, it is contemplated that the existing building structure to which the pesticidal baits are added could have been previously treated with the pesticidal baits during the construction process for example. In another aspect of this form, one or more of the pesticidal baits described herein could be spread across the crawlspace of an existing building structure. In yet another aspect of this form, at least part of the soil surrounding the foundation of an existing building structure could be removed to facilitate the burial of one or more pesticidal baits, although use of the pesticidal baits in an above-the-ground application around an existing building structure is also contemplated. Additionally or alternatively, one or more of the pesticidal baits described herein could also be added to one or more locations inside an existing building structure, such as an attic or basement, although other locations are possible and contemplated.

While not specifically discussed above, it should be appreciated that the pesticidal baits employed in systems 10, 40, 70 may be freestanding; i.e., they do not include nor are they positioned in any housing, station, enclosure, or other type of structure. Similarly, the soil, fill, earth, or other medium in which the pesticidal baits are positioned is in direct contact with the external surface of the pesticide-bearing material. However, forms in which one or more of the pesticidal baits are positioned in a housing or station are also possible.

In the diagrammatic illustrations of FIGS. 1-3, it should be appreciated that the positioning of pesticidal baits 12, 42, 72 relative to foundations 14, 44, 74 is only shown in two dimensions. However, as discussed at various locations above, it should be understood that pesticidal baits 12, 42, 72 may be also be positioned in an arrangement that extends around the interior and/or exterior perimeters of foundations 14, 44, 74 and/or across an area that is the same size as or greater than the footprint or surface area over which foundations 14, 44, 74 or any elements thereof are positioned. Moreover, the number of pesticidal baits 12, 42, 72 and the arrangements thereof illustrated in FIGS. 1-3 are exemplary only, and other variations are contemplated and expected. More particularly, as would be appreciated by those skilled in the art, the number of pesticidal baits used around and/or under a certain foundation may be dependent on the size and shape of the pesticidal bait, the concentration of pesticide in the pesticidal baits, the area in which the pesticidal baits are being positioned, and the size and type of the foundation for which the pesticidal baits are being employed.

While also not previously discussed above, it should be appreciated that baits 12, 42, 72 can be provided for and arranged in systems 10, 40, 70 by a single entity or individual, although forms where more than one entity or individual cooperate to provide baits 12, 42, 72 and arrange them in systems 10, 40, 70 are also possible. For example, in one more specific form where a single entity provides and arranges baits 12, 42, 72, a construction company or a pest service provider brings baits 12, 42, 72 to the site or location where systems 10, 40, 70 will be installed and then proceeds with installing baits 12, 42, 72 as discussed and described herein. As another example, in one more specific form where multiple entities or parties are involved with the provision and arrangement of baits 12, 42, 72 with respect to systems 10, 40, 70, a manufacturer, wholesaler, distributor, seller or other provider of baits 12, 42, 72 directly or indirectly sends or supplies baits 12, 42, 72 to the site or location where systems 10, 40, 70 will be installed and then another entity or party, such as a construction company or a pest service provider, arranges baits 12, 42, 72 in systems 10, 40, 70 as discussed and described herein. In one aspect of this form, the manufacturer, wholesaler, distributor, seller or other provider of baits 12, 42, 72 also provides instructions or directions for arranging baits 12, 42, 72 in systems 10, 40, 70 as discussed and described herein. Still, it should be appreciated that alternative arrangements for the provision and positioning of baits 12, 42, 72 are also contemplated and fall within the scope of the subject application.

Without being limited to any particular form, FIGS. 4-6 provide various examples of forms in which the pesticidal baits described herein may be provided. As illustrated in FIG. 4 for example, the pesticidal bait may be in the form of a puck or disk 94. When provided in the form of puck 94, the pesticidal baits may weigh between about 1 and about 50 grams. In another aspect of this form, the pesticidal baits may weigh between about 1 and about 40 grams. In yet another aspect of this form, the pesticidal baits may weigh between about 1 and about 30 grams. Still, in another aspect of this form, the pesticidal baits may weigh between about 1 and about 20 grams. In another aspect of this form, it is contemplated that the pesticidal baits may weigh between about 1 and about 15 grams. In still another aspect of this form, it is contemplated that the pesticidal baits may weigh between about 2 and about 14 grams. Still, in another aspect, it is contemplated that the pesticidal baits may weigh between about 3 and about 13 grams. In yet another aspect, it is contemplated that the pesticidal baits may weigh between about 4 and about 12 grams or, more particularly, between about 8 and about 12 grams. However, other variations for the weight of the pesticidal baits in the form of puck 94 are contemplated and fall within the scope of the present application. In addition, it is contemplated that puck 94 can include a diameter between about 18 and about 40 millimeters or, more particularly, between about 24 and about 36 millimeters. In one form, puck 94 can include a thickness between about 8 and about 16 millimeters or, more particularly, between about 10 and about 14 millimeters. It should be appreciated however that alternative values for the diameter and thickness of puck 94 are also contemplated.

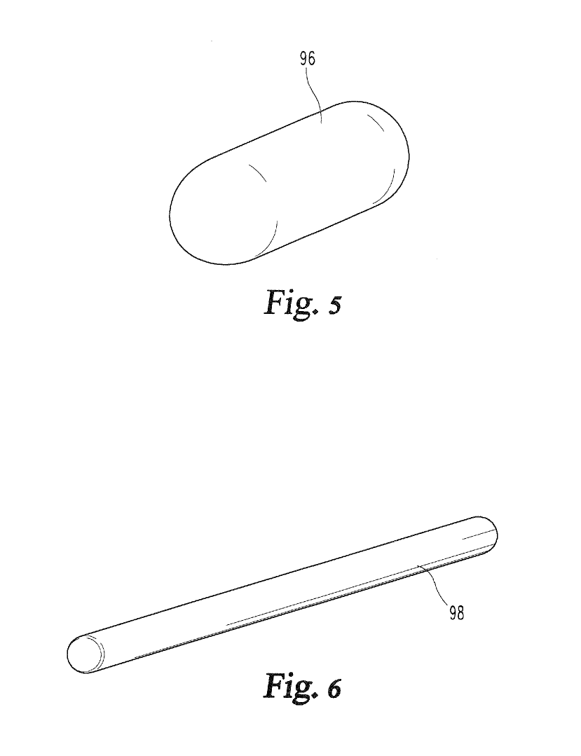

With reference to FIG. 5, the pesticidal bait may be in the form of a tablet 96. When provided in the form of tablet 96, the pesticidal baits may weigh between about 0.1 and about 10 grams. In another aspect of this form, it is contemplated that the pesticidal baits may weigh between about 0.1 and about 8 grams. In still another aspect of this form, it is contemplated that the pesticidal baits may weigh between about 0.1 and about 6 grams. In yet another aspect of this form, it is contemplated that the pesticidal baits may weigh between about 0.1 and about 4 grams. In another aspect of this form, it is contemplated that the pesticidal baits may weigh between about 0.1 and about 2 grams. Still, in another aspect of this form, it is contemplated that the pesticidal baits may weigh between about 0.1 and about 1 grams. In another aspect of this form, it is contemplated that the pesticidal baits may weigh between about 0.1 and about 0.6 grams. Still, in another aspect, it is contemplated that the pesticidal baits may weigh between about 0.1 and about 0.5 grams. In yet another aspect, it is contemplated that the pesticidal baits may weigh between about 0.2 and about 0.4 grains or, more particularly, between about 0.2 and about 0.3 grams. However, other variations for the weight of the pesticidal baits in the form of tablet 96 are contemplated and fall within the scope of the present application. In addition, it is contemplated that tablet 96 can include a diameter between about 4 and about 12 millimeters or, more particularly, between about 6 and about 10 millimeters. In one toxin, tablet 96 can include a thickness between 1 and 8 millimeters or, more particularly, between about 2 and about 6 millimeters. It should be appreciated however that alternative values for the diameter and thickness of tablet 96 are also contemplated.

In yet another form illustrated in FIG. 6, the pesticidal bait can be provided in the form of an elongated rod 98. When provided in the form of rod 98, the pesticidal baits may weigh between about 1 and about 50 grams. In another aspect of this form, the pesticidal baits may weigh between about 1 and about 40 grams. In yet another aspect of this form, the pesticidal baits may weigh between about 1 and about 30 grams. Still, in another aspect of this form, the pesticidal baits may weigh between about 1 and about 20 grams. In another aspect of this form, it is contemplated that the pesticidal baits may weigh between about 1 and about 15 grams. In another aspect of this form, it is contemplated that the pesticidal baits may weigh between about 2 and about 14 grams. Still, in another aspect, it is contemplated that the pesticidal baits may weigh between about 3 and about 13 grams. In yet another aspect, it is contemplated that the pesticidal baits may weigh between about 4 and about 12 grams or, more particularly, between about 8 and about 12 grams. However, other variations for the weight of the pesticidal baits in the form of rod 98 are contemplated and fall within the scope of the present application. In addition, it is contemplated that rod 98 can include a diameter between about 10 and about 26 millimeters or, more particularly, between about 16 and about 24 millimeters. In one form, rod 98 can include a length between about 30 and about 70 millimeters or, more particularly, between about 40 and about 60 millimeters. It should be appreciated however that alternative values for the diameter and length of rod 98 are also contemplated.

Still, other variations in the size, shape and weight of the pesticidal baits are also possible. For example, it is also contemplated that the pesticidal bait could be provided in the form of a powder, dust or granule, just to provide a few non-limiting examples. In another form, the pesticidal baits are provided in a solid or semi-solid form. Moreover, it should be understood that systems 10, 40 and 70 can utilize pesticidal baits that are provided in more than one of the forms contemplated by the present application. More particularly, in system 10 for example, it is contemplated that one or more of pesticidal baits 12a-f can be provided in the form of puck 94 while another one or more of pesticidal baits 12a-f can be provided in the form of tablet 96 or rod 98, just to provide a few possibilities. In addition, pesticidal baits 12, 42, 72 shown in the illustrated embodiments may be representative of a single pesticidal bait, such as puck 94 for example, or a plurality of pesticidal baits, such as a plurality of tablets 96. Similarly, when a plurality of tablets 96 is used for example, the location of their positioning may extend beyond the location represented by the illustrated pesticidal baits 12, 42, 72.

In one form, the placement of the pesticidal baits around and/or under the foundation of a building may be performed randomly or in accordance with a predetermined gridwork. For example, in one form in which the pesticidal baits utilized are in the form of puck 94, it is contemplated that they can be positioned in an arrangement where they are between about 5 and about 15 feet on center relative to each other, although other variations are possible. Moreover, when pesticidal baits in the form of puck 94 or rod 98 are used, they may be hand placed at their respective locations at the building site. In another form where pesticidal baits in the form of tablets 96 are used, it is contemplated that they may be placed at their respective locations at the building site with a broadcast or other type of mechanical spreader for example. Still, other approaches for placing the pesticidal baits, regardless of their respective form, are contemplated.

Regardless of the shape, size, weight, or the like, in certain embodiments, the pesticidal bait is in the form of a solid member. In one example, the bait includes a carrier in the solid phase at standard temperature and pressure that carries one or more pesticides that may be solid at standard temperature and pressure or otherwise (such as a liquid absorbed by or otherwise contained within the carrier). In one form, the carrier is a matrix palatable to the targeted pests and at least one pesticide is dispersed throughout. In another form, the pesticidal baits described herein generally include a bait material that is palatable to one or more species of pests and a pesticide that is toxic to the one or more species of pests. In one embodiment, the bait material is a cellulosic food material that is selected based upon known or measured attractability for a given pest that is being targeted. In one aspect for example, when the pesticidal bait is to be used to target a certain pest species, the pesticidal bait can be made using a cellulosic food material that is a favorite food of the target pest species. The cellulosic food material would therefore be palatable to members of the target pest species, such as termites, and would be expected to be consumed or displaced by the pests, which would result in the simultaneous consumption or displacement of the pesticide present in the pesticidal bait, producing a desired pesticidal effect. In one embodiment, the food material is a purified cellulose, such as, for example, alpha cellulose, including compressed alpha cellulose. One non-limiting example of compressed alpha cellulose includes preferred texture cellulose (PTC). In another embodiment, the food material is wood or a derivative of wood. Non-limiting examples of wood and wood derivatives include wood chips, wood fibers, sawdust, cardboard, paper or other material that is palatable to a targeted wood-destroying species. Other cellulosic food materials that can be employed include microcrystalline cellulose, examples of which are provided in U.S. Pat. No. 6,416,752, the contents of which are incorporated herein by reference in their entirety, and modified polymeric cellulose based materials such as, for example, METHOCEL® or ETHOCEL®, which are available commercially from The Dow Chemical Company, Midland, Mich.

The pesticide is one that kills pests that ingest or contact the pesticide. In one aspect, the pesticide retains its bioactivity as it resides within the pesticidal bait and, when applicable, for a period of time following the biodegradation/dissolution of the bait material, and produces a desired result after it is ingested by or otherwise comes into contact with pests. Some of the pesticides that can be employed in the pesticidal baits disclosed herein include, but are not limited to the following:

1,2-dichloropropane,

abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-ecdysone, alpha-endosulfan, amidithion, aminocarb, amiton, amiton oxalate, amitraz, anabasine, athidathion, azadirachtin, azamethiphos, azinphos-ethyl, azinphos-methyl, azothoate,

barium hexafluorosilicate, barthrin, bendiocarb, benfuracarb, bensultap, beta-cyfluthrin, beta-cypermethrin, bifenthrin, bioallethrin, bioethanomethrin, biopermethrin, bistrifluron, borax, boric acid, bromfenvinfos, bromocyclen, bromo-DDT, bromophos, bromophos-ethyl, bufencarb, buprofezin, butacarb, butathiofos, butocarboxim, butonate, butoxycarboxim,

cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chromafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate,

DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, diehlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin,

ecdysterone, emamectin, emamectin benzoate, EMPC, empenthrin, endosulfan, endothion, endrin, EPN, epofenonane, eprinomectin, esdepalléthrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD,

famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flometoquin, flonicamid, flubendiamide (additionally resolved isomers thereof), flucofuron, flucycloxuron, flucythrinate, flufenerim, flufenoxuron, flufenprox, flufliprole, flupyradifurone, fluvalinate, fonofos, formetanate, formetanate hydrochloride, formothion, formparanate, formparanate hydrochloride, fosmethilan, fospirate, fosthietan, fufenozide, furathiocarb, furethrin,

gamma-cyhalothrin, gamma-HCH,

halfenprox, halofenozide, HCH, HEOD, heptachlor, heptenophos, heterophos, hexaflumuron, HHDN, hydramethylnon, hydrogen cyanide, hydroprene, hyquincarb,

imidacloprid, imiprothrin, indoxacarb, iodomethane, IPSP, isazofos, isobenzan, isocarbophos, isodrin, isofenphos, isofenphos-methyl, isoprocarb, isoprothiolane, isothioate, isoxathion, ivermectin,

jasmolin I, jasmolin II, jodfenphos, juvenile hormone I, juvenile hormone II, juvenile hormone

kelevan, kinoprene,

lambda-cyhalothrin, lead arsenate, lepimectin, leptophos, lindane, lirimfos, lufenuron, lythidathion,

malathion, malonoben, mazidox, mecarbam, mecarphon, menazon, meperfluthrin, mephosfolan, mercurous chloride, mesulfenfos, metaflumizone, methacrifos, methamidophos, methidathion, methiocarb, methocrotophos, methomyl, methoprene, methothrin, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, monocrotophos, monomehypo, monosultap, morphothion, moxidcctin,

naftalofos, naled, naphthalene, nicotine, nifluridide, nitenpyram, nithiazine, nitrilacarb, novaluron, noviflumuron,

omethoate, oxamyl, oxydemeton-methyl, oxydeprofos, oxydisulfoton,

para-dichlorobenzene, parathion, parathion-methyl, penfluron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluralin, profluthrin, promacyl, promecarb, propaphos, propetamphos, propoxur, prothidathion, prothiofos, prothoate, protrifenhute, pymetrozine, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen,

quassia, quinalphos, quinalphos-methyl, quinothion,

rafoxanide, resmethrin, rotenone, ryania,

sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulcofuron-sodium, sulfluramid, sulfotep, sulfoxaflor, sulfuryl fluoride, sulprofos,

tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypermethrin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlometaphos-3, trichloronat, trifenofos, triflumuron, trimethacarb, triprene,

vamidothion, vaniliprole,

XMC, xylylcarb,

zeta-cypermethrin, and zolaprofos.

Additionally, any combination of the above pesticides can be used.

For more information consult “Compendium of Pesticide Common Names” located at http://www.alanwood.net/pesticides/index.html as of the filing date of this document. Also consult “The Pesticide Manual” 15th Edition, edited by C D S Tomlin, copyright 2009 by British Crop Production Council.

In one embodiment, the pesticide is one that has an immediate effect upon ingestion by or contact with a pest (referred to herein as an “immediate action” pesticide or a “fast acting” pesticide). For example, insecticides that have immediate killing action upon ingestion by termites include chlorpyrifos, spinosad, imidacloprid and fipronil, each of which is well known and available commercially. As used herein, the term “immediate” is intended to mean that the pesticide typically operates to kill an individual pest before the pest returns to its colony. In another embodiment, the pesticide is one that exhibits a delayed effect upon ingestion by or contact with a pest (referred to herein as a “delayed action” pesticide). Non-limiting examples of insecticides that have delayed killing activity upon ingestion by or contact with termites include hexaflumuron and noviflumuron, each of which is well known and available commercially. As used herein, the term “delayed” is intended to mean that the pesticide typically does not operate to kill an individual pest until after the pest has returned to its colony. In another embodiment, the pesticide is selected from the group consisting of hexaflumuron, lufenuron, flufenoxuron, diflubenzuron, bistrifluron, sulfuramid, hydramethylnon, novaluron and noviflumuron.

In one form, the composition of the pesticidal baits is limited to the bait material and the pesticide. However, in addition to the bait material and the pesticide, other ingredients can optionally be included in the pesticidal bait. For example, some ingredients can be included to increase the stability or shelf life of the pesticide included in the pesticidal bait. Other ingredients can be selected to improve the processability of the mixture, or to provide an advantageous effect after the pesticidal bait is formed. Still other ingredients can be selected, for example, to attract pests to the baits or to stimulate feeding. The pesticidal baits disclosed herein can also include or be used with herbicides and fungicides, both for reasons of economy and synergy. The pesticidal baits disclosed herein can also include or be used with antimicrobials, bactericides, defoliants, safeners, synergists, algaecides, attractants, desiccants, pheromones, repellants, animal dips, avicides, disinfectants, semiochemicals, and molluscicides (these categories not necessarily mutually exclusive) for reasons of economy and synergy. In addition, it is contemplated that one or more binders or binding agents could be included in the pesticidal baits. Still, in another form, the pesticidal bait includes a thermoplastic polymer material in addition to the bait material and the pesticide, non-limiting examples of which are described in International Patent Publication No. WO 2008/079384. In one embodiment, the pesticidal baits include from about 0.001% to about 5% by weight pesticide. In yet another embodiment, the pesticidal baits include from about 0.1% to about 5% by weight pesticide. In still another embodiment, the pesticide is present in an amount in the range of from about 0.1% to about 4% by weight. In another embodiment, the pesticide is present in an amount from about 0.2% to about 3% by weight. Still, in another embodiment, the pesticide is present in an amount from about 0.3% to about 2% by weight. However, it should be appreciated that alternative values for the amount of pesticide present in the pesticidal baits described herein are possible.

In one form, the pesticidal baits described herein can be formed by extruding a mixture of the bait material and the pesticide into a desired shape, such as the shape of puck 94, tablet 96 or rod 98, just to provide a few examples. In one particular form, the pesticidal baits can be formed by mixing a thermoplastic polymer, wood fragments or other cellulosic materials, and a pesticide, creating a molten or flowable material from the resulting mixture, and extruding or molding the molten material into a desired final shape. Further examples and details of suitable extruded pesticidal baits are found in International Patent Application Publication No. WO 2008/079384. Another example of a suitable extruded pesticidal bait is Recruit® HD, which is commercially available from Dow AgroSciences, LLC, 9330 Zionsville Road, Indianapolis, Ind. 46268.

In another form, the pesticidal baits described herein can be formed by grinding a mixture of the bait material and the pesticide in a grinder and then processing the ground material in a press (such as a Carver press) to provide a compressed form of the pesticidal baits.

It should be appreciated that the press can be configured to provide the compressed form of the pesticidal baits with a desirable configuration, such as puck 94, tablet 96 or rod 98, among other possibilities. In one form, the pesticidal baits are compressed at a pressure between about 5,000 and about 40,000 psi. In another form, the pesticidal baits are compressed at a pressure between about 10,000 and about 35,000 psi. Still, in another form the pesticidal baits are compressed at a pressure between about 12,000 and about 26,000 psi. However, it should be appreciated that additional variations in the pressure at which the pesticidal baits are compressed are contemplated. Moreover, a wide variety of material specifications and process parameters can affect the pressure at which the pesticidal baits are compressed. Still, other approaches contemplated for forming the pesticidal baits include extrusion (with or without post-extrusion processing), original mold design (with or without post-molding processing), and injection molding, just to provide a few non-limiting possibilities.

In one approach, the bait material, such as purified alpha cellulose for example, is pre-loaded with the pesticide before being ground in the grinder. In one manner of pre-loading, the pesticide is sprayed directly on cellulose particles, and the mixture of cellulose particles and pesticide is then compacted and broken into prills, which include the cellulose food material and the pesticide therein. When this approach is used, the pesticide is referred to as “incorporated in cellulose,” and this method is referred to as an “incorporated in cellulose” method. In another manner of pre-loading the bait material with the pesticide, pre-formed prills of cellulose (which are available commercially, and can be obtained from International Fibers Corporation, North Tonawanda, N.Y.) are sprayed with the pesticide to provide a pre-loaded cellulose material. When this approach is used, the pesticide is referred to as “sprayed on cellulose,” and this method is referred to as a “sprayed on cellulose” method. Still, in another approach, one or more Shatter™ termite baits (commercially available from Dow AgroSciences, LLC, 9330 Zionsville Road, Indianapolis, Ind. 46268) can be ground in the grinder and then processed with the press. The Shatter™ termite baits include a bait material in the form of cellulose and a pesticide in the form of hexaflumuron.

### EXAMPLES

The following examples are for illustration purposes and are not to be construed as limiting the invention disclosed in this document to only the embodiments disclosed in these examples.

### Example I

### Example Pesticidal Baits

### Example A

A plurality of 0.5% by weight hexaflumuron pucks were each prepared in accordance with the following approach. A hexaflumuron preferred texture cellulose material provided by Ag Formulators, Inc., 5427 E. Central Ave., Fresno, Calif. 93725, was milled in a Fitzmill Model D Communiter fitted with a 0.5 inch round-hole screen to provide a coarse powder. The coarse powder was then sifted through an 8 mesh sieve to remove any oversize particles. Three five gram aliquots of the sifted course powder were then added to a 32 mm die of a Carver Press. Each aliquot was compacted by hand with the die punch to allow the addition of a subsequent five gram aliquot in the void volume created. After the final five gram aliquot was added, the fully charged die was compressed hydraulically at one of the pressures set forth in Table 1 below. The resulting weight, diameter, thickness, volume and density of each puck are also set forth in Table 1 below.

TABLE 1

| Puck | Weight | Pressure | Diameter | Thickness | Volume | Density |
|---|---|---|---|---|---|---|
| No. | (g) | (psi) | (in) | (in) | (in³) | (g/mL) |
| 1A | 9.53 | 24000 | 1.148 | 0.453 | 0.468 | 1.241 |
| 2A | 10.06 | 20000 | 1.148 | 0.488 | 0.504 | 1.217 |
| 3A | 10.01 | 15000 | 1.148 | 0.500 | 0.517 | 1.181 |
| 4A | 9.72 | 24000 | 1.140 | 0.458 | 0.467 | 1.268 |
| 5A | 9.89 | 24000 | 1.142 | 0.468 | 0.478 | 1.261 |

### Example B

A plurality of 0.5% by weight hexaflumuron tablets were each prepared in accordance with the following approach. Remaining portions of the coarse powder used in the approach to make the pucks in Example A were fed to a Carver press fitted with tablet tooling from a Stokes tablet press and compressed at one of the pressures set forth in Table 2 below. The resulting weight, diameter, thickness, volume and density of each tablet are also set forth in Table 2 below.

TABLE 2

| Tablet | Weight | Pressure | Diameter | Thickness | Volume | Density |
|---|---|---|---|---|---|---|
| No. | (g) | (psi) | (mm) | (mm) | (mL) | (g/mL) |
| 1B | 0.25 | 25670 | 8 | 4.07 | 0.205 | 1.22 |
| 2B | 0.25 | 25670 | 8 | 4.14 | 0.208 | 1.20 |
| 3B | 0.25 | 19253 | 8 | 3.89 | 0.196 | 1.28 |
| 4B | 0.25 | 19253 | 8 | 4.05 | 0.204 | 1.23 |
| 5B | 0.25 | 12835 | 8 | 4.38 | 0.220 | 1.14 |
| 6B | 0.25 | 12835 | 8 | 4.35 | 0.219 | 1.14 |

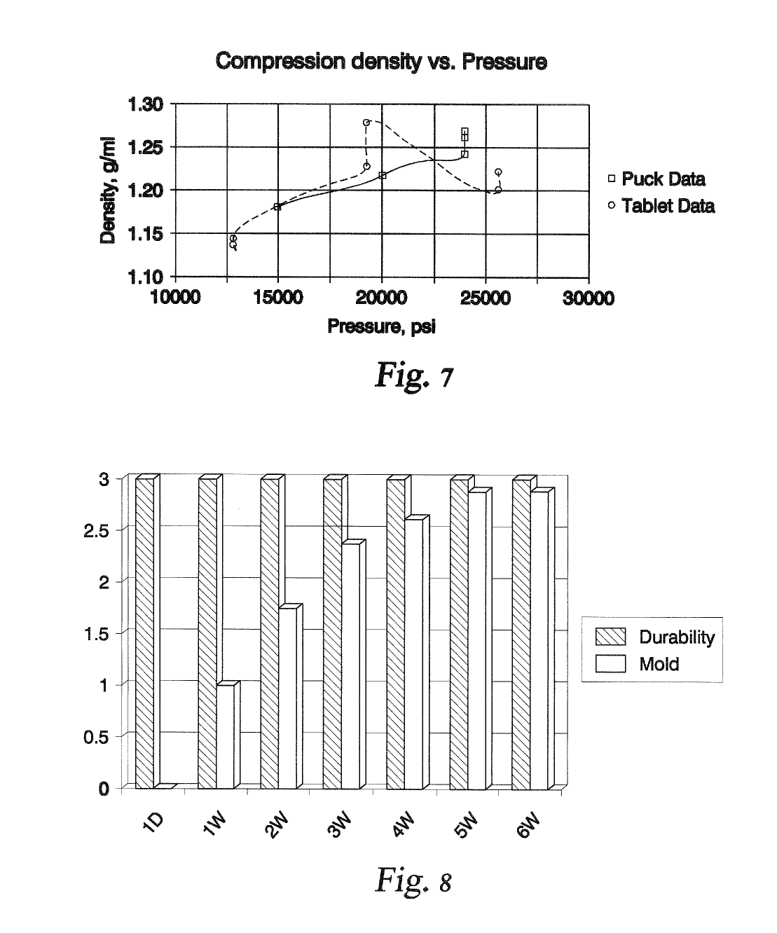

FIG. 7 provides a graphical illustration of compression density of the puck and tablet versus pressure applied during formation of the respective puck and tablet.

### Example II

### Durability Testing

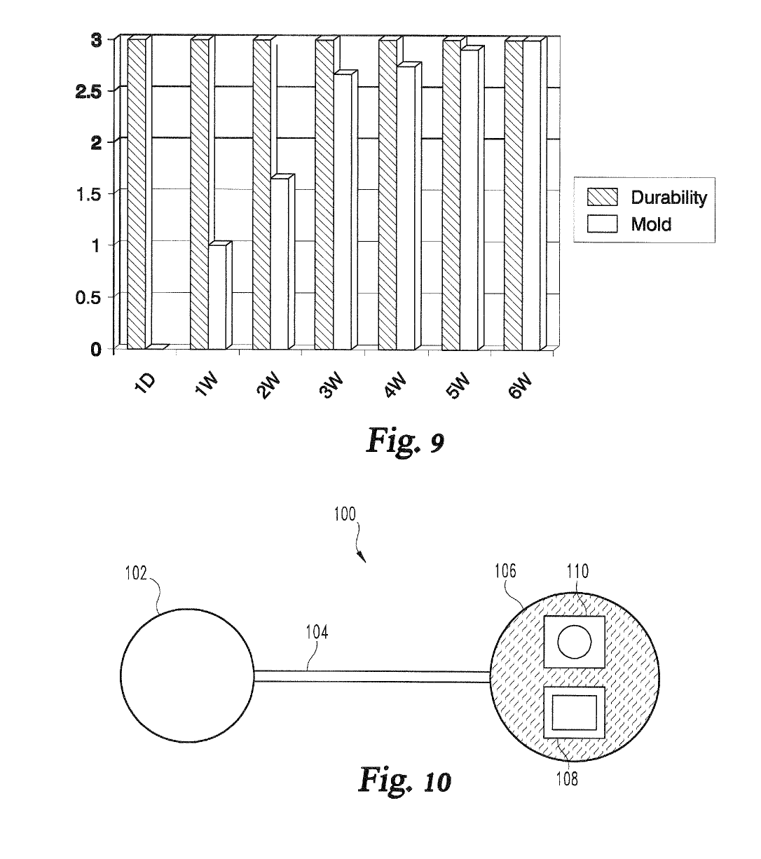

Durability testing was performed on pesticidal bait pucks prepared in accordance with the approach outlined under Example A above and compressed at approximately 20,000 psi, and on pesticidal bait tablets prepared in accordance with the approach outlined under Example B above and compressed at approximately 20,000 psi. Four four-inch clay pots were filled with dry Fowler soil. Water was added to the Fowler soil of two of the tilled pots until the Fowler soil became moist. The soil in these two pots was then kept moist by sub-irrigation only as it became dried out. One puck was placed on top of the soil in one of the pots with dry soil and on top of the soil in one of the pots with moist soil. Additionally, two tablets were placed on top of the soil in the other of the pots with dry soil and on top of the soil in the other of the pots with moist soil. All four of the pots were then covered with four inch by four inch ceramic tiles and placed in a greenhouse. The pucks and tablets were then inspected at one day and at one, two, three, four, five and six weeks for durability and mold. The scale for durability in these inspections is as follows: 0=like new; 1=slight deterioration/cracking/flaking; 2=moderate deterioration/beginning to break apart; and 3=completely compromised/totally broken apart. Moreover, the scale for mold in these inspections is as follows: 0=none; 1=slight; 2=moderate; and 3=heavy. The puck in the dry soil had ratings of 0 for both durability and mold ratings for the entire six weeks of the study. In addition, the tablets in the dry soil had ratings of 0 for both durability and mold ratings for the entire six weeks of the study. The results from the inspections of the pucks and tablets in the pots with moist soil are shown in the bar graphs of FIGS. 8 and 9, respectively.

### Example III

### Palatability Testing

Termite palatability testing was performed on pesticidal bait pucks prepared in accordance with the approach outlined under Example A above and compressed at approximately 20,000 psi, and on pesticidal bait tablets prepared in accordance with the approach outlined under Example B above and compressed at approximately 20,000 psi. Consumption of the pesticidal bait pucks and tablets was compared to consumption of southern yellow pine (SYP). More particularly, an apparatus 100 illustrated in FIG. 10 includes a harborage chamber 102 filled with sand and vermiculite. Apparatus 100 also includes a foraging chamber 106 filled with moist soil, and a tube 104 connected to and extending between chamber 102 and chamber 106. Tube 104 provides access to chamber 106 from chamber 102.

In one test, two 2.5-g pieces of a pesticidal bait puck were placed on half of a plastic weigh boat 110 in chamber 106 on top of the soil and a piece of SYP was placed on another half of a plastic weight boat 108 in chamber 106 on top of the soil. One hundred termites (Reticulitermes flavipes) were positioned in chamber 102 for seven days. At the end of seven days, the pesticidal bait puck pieces were oven-dried for eight hours at 400° F. and the SYP was oven dried at 120° F. for 24 hours. The pesticidal bait puck pieces and the SYP were then weighed to determine the amount of consumption. This test was performed a total of six times. The results of the pesticidal bait puck termite consumption compared to the SYP termite consumption are provided in Table 3 below.

In another test, five 0.25-g pesticidal bait tablets were placed on half of a plastic weigh boat 110 in chamber 106 on top of the soil and a piece of SYP was placed on another half of a plastic weight boat 108 in chamber 106 on top of the soil. One hundred termites (Reticulitermes flavipes) were positioned in chamber 102 for seven days. At the end of seven days, the pesticidal bait tablets were oven-dried for eight hours at 400° F. and the SYP was oven dried at 120° F. for 24 hours. The pesticidal bait puck pieces and the SYP were then weighed to determine the amount of consumption. This test was performed a total of six times. The results of the pesticidal bait tablet termite consumption compared to the SYP termite consumption are provided in Table 3 below. In addition, three controls of each test were performed to correct for weight loss.

TABLE 3

| | mg consumed ± SEM | Palatability Ratio |
|---|---|---|
| Test | (p-value) | (Pesticidal bait/SYP) |
| #1 | 38.41 ± 10.0 | 8.6 |
| Pesticidal bait puck | 4.47 ± 1.7 | |
| SYP | (p = 0.015) | |
| #2 | 28.66 ± 6.24 | 4.86 |
| Pesticidal bait tablets | 5.90 ± 1.62 | |
| SYP | (p = 0.015) | |

### Example IV

### Efficacy Testing

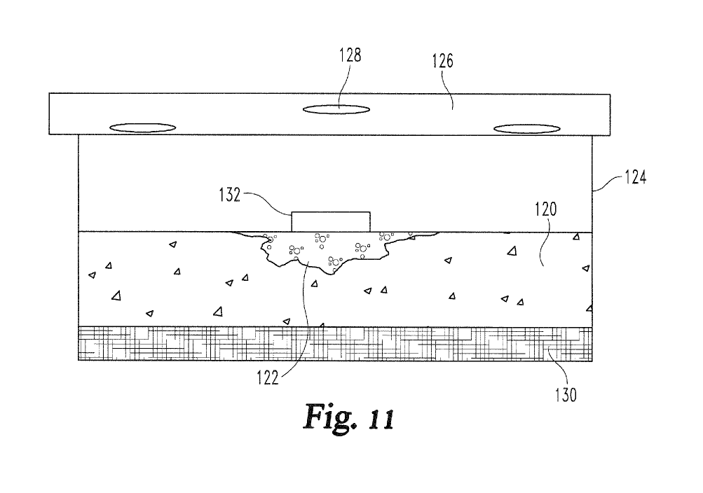

Testing was performed to determine the effect of pesticidal bait puck residues in soil on survivorship of Reticulitermes flavipes. More particularly, as illustrated in FIG. 11, soil 120 having an area of pesticidal bait puck residue 122 was positioned in a three-cup glass container 124 with lid 126. Lid 126 includes a plurality of ventilation holes 128 and soil 120 was positioned above a layer of vermiculite 130. Soil 120 was obtained from the above described “Durability Testing” where 0.5% hexaflumuron pesticidal bait pucks had dissolved. A piece of SYP 130 was positioned on top of soil 120 near residue area 122. A second control container was filled with Fowler soil without any pesticidal bait residue and a piece of SYP was positioned on top of the Fowler soil in a manner similar to the arrangement illustrated in FIG. 11. Two hundred termites (Reticulitermes flavipes) were then added to each container for forty-two days. At the end of forty-two days, the amount of the SYP consumed in each container was measured and the survivorship of the termites was determined. These tests were performed a total of four times. The results are provided below in Table 4.

TABLE 4

| | | Palatability Ratio | |
|---|---|---|---|
| | mg of SYP | (SYP in control | Survivorship |
| | consumed ± SEM | soil/SYP in | (%) |
| Test Soil | (p-value) | residue soil) | (p-value) |
| Pesticidal Bait Puck | 104.2 ± 5.4 | 1.48 | 25 |
| Residue Soil | (p = 0.053) | | (p = 0.035) |
| Control Soil | 154.5 ± 17.4 | | 50 |
| | (p = 0.053) | | (p = 0.035) |

### Example V

### Efficacy Testing

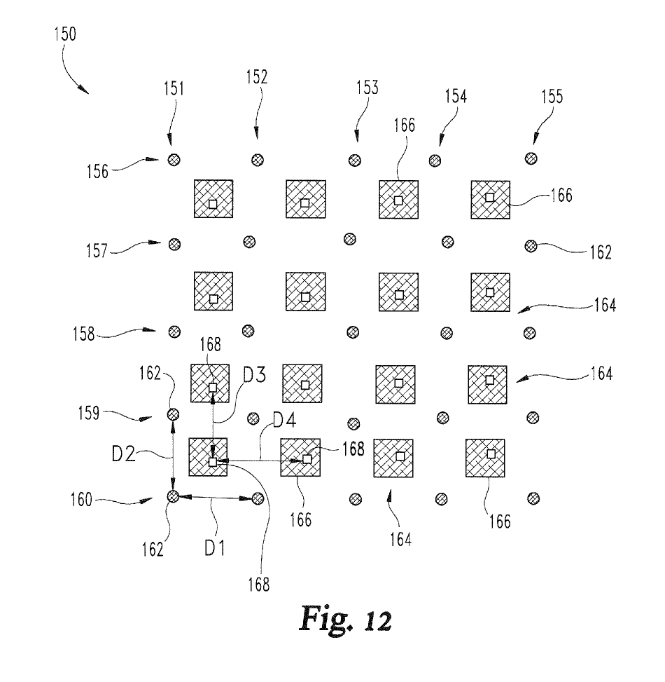

Testing was performed to determine the effect in the field of pesticidal bait pucks as described in U.S. patent application Ser. No. 12/004,655 on Reticulitermes flavipes, Reticulitermes hageni and Coptotermes formosanus. More particularly, pesticidal bait pucks were applied in an artificially constructed grid 150 (FIG. 12) at three separate sites to observe whether termites would find and consume the bait, and if bait consumption impacted termite activity at each of the respective sites. As illustrated in FIG. 12, grid 150 includes a plurality of in-ground stations 162 positioned in columns 151-155 and rows 156-160. Only a few of stations 162 have been referenced to preserve clarity. Columns 151-155 are spaced relative to one another such that a distance D1 of 10 feet extends between stations 162 in a single row in adjacent ones of columns 151-155. In addition, rows 156-160 are spaced relative to one another such that a distance D2 of 10 feet extends between stations 162 in a single column in adjacent ones of rows 156-160. In this arrangement, stations 162 define a plurality of cells 164, only a few of which have been referenced to preserve clarity. One of stations 162 is positioned at each corner of cells 164 such that cells 164 have a 10 feet by 10 feet square configuration. A pesticidal bait puck 168 was positioned in the middle of each of cells 164 and a concrete mini-slab 166 was positioned over each of the pesticidal bait pucks 168. Similarly, a distance of 10 feet extends between pesticidal bait pucks 168 in adjacent rows and columns as indicated by reference numerals D3 and D4. It should be understood that only a few of mini-slabs 166 and pesticidal bait pucks 168 have been referenced in order to preserve clarity.

Stations 162 were each provided with a piece of SYP in order to independently monitor termite activity and compare termite activity with respect to the pesticidal bait pucks 168 and the SYP pieces in stations 162. More particularly, each of the pesticidal bait pucks 168 and the SYP pieces in stations 162 was inspected for evidence of termite feeding for each of the above-identified species. The results of these observations are provided in Table 5 below.

TABLE 5

| | Number of Bait Pucks | Number of SYP Pieces |
|---|---|---|
| | Exhibiting Evidence | Exhibiting Evidence |
| | of Termite | of Termite |
| | Feeding of Relevant | Feeding of Relevant |
| Termite Species | Species/Total Number | Species/Total Number |
| (Site Number) | of Bait Pucks | of SYP Pieces |
| Reticulitermes flavipes | 12/16 | 1/25 |
| (Site 1) | | |
| Coptotermes formosanus | 9/16 | 4/25 |
| (Site 1) | | |
| Reticulitermes hageni | 7/16 | 6/25 |
| (Site 1) | | |
| Coptotermes formosanus | 3/16 | 3/25 |
| (Site 2) | | |
| Reticulitermes flavipes | 16/16 | 3/25 |
| (Site 2) | | |
| Reticulitermes flavipes | 7/16 | 6/25 |
| (Site 3) | | |

In one embodiment, a method includes providing at least one bait including a bait material palatable to one or more species of pest and a pesticide, and positioning the at least one bait at a location to lie underneath a foundation element of a building structure. In one form of this embodiment, the at least one bait is formed by a compressed mixture of the bait material and the pesticide. In another form, the at least one bait is formed by an extruded mixture of the bait material and the pesticide. In one aspect, positioning the at least one bait follows excavation of the location for placement of the foundation element and precedes placement of the foundation element. In a further aspect, the pesticide is selected from the group consisting of noviflumuron, hexaflumuron, lufenuron, flufenoxuron, diflubenzuron, bistrifluron, sulfuramid, novaluron and hydramethylnon. In still a further aspect, the bait material comprises alpha cellulose. In a further aspect, the foundation element is a concrete footing or concrete slab. In a further aspect, the bait material comprises alpha cellulose and the pesticide comprises hexaflumuron. In a further aspect, the at least one bait weighs between 1 and 50 grams. In still a further aspect, the at least one bait weighs between 0.1 and 10 grams.

In another embodiment, a method includes providing a plurality of pesticidal baits each including a solid carrier material bearing a pesticide; positioning a first one of the pesticidal baits underneath a lower terminus of a building foundation; and positioning a second one of the pesticidal baits proximate to the foundation below ground level and at a depth less than the first one of the pesticidal baits. In one aspect, each of the plurality of pesticidal baits is defined by a compressed composite including a bait material and the pesticide. In a further aspect, the bait material is bio-degradable. In yet a further aspect, each of the plurality of pesticidal baits is defined by an extruded composite including a bait material and the pesticide. In a further aspect, the bait material comprises alpha cellulose. In still a further aspect, the pesticide is selected from the group consisting of noviflumuron, hexaflumuron, lufenuron, flufenoxuron, diflubenzuron, bistrifluron, sulfuramid, novaluron and hydramethylnon. In a further aspect, the foundation is comprised of a plurality of elements and the positioning of the first one of the pesticidal baits includes placement below a first one of the elements and the positioning of the second one of the pesticidal baits includes placement adjacent to a second one of the elements which is positioned on the first one of the elements. In one aspect, the first one of the elements is a foundation footing and the second one of the elements is a foundation wall. In one form, the method includes placing each of the plurality of pesticidal baits below ground level, and suspending each of the plurality of pesticidal baits in fill.

In a further aspect, the method includes successively placing each additional one of the plurality of pesticidal baits below ground level at a different depth relative to any other of the plurality of pesticidal baits. In a further aspect, the method includes excavating a foundation hole; establishing a first layer of fill material in the foundation hole having an upper margin below the lower terminus of the foundation; placing the first one of the pesticidal baits on the first layer of fill material; establishing a second layer of fill material in the foundation hole; placing the second one of the pesticidal baits on the second layer of fill material; and covering the second one of the pesticidal baits with a third layer of fill material. A further aspect includes positioning a third one of the pesticidal baits on the third layer of fill material and covering the third one of the pesticidal baits with a fourth layer of fill material. In still a further aspect, the method includes positioning a fourth one of the pesticidal baits on the fourth layer of fill material and covering the fourth one of the pesticidal baits with a fifth layer of fill material. In one aspect, at least the second one of the pesticidal baits, the third one of the pesticidal baits, and the fourth one of the pesticidal baits are at different depths spaced apart from each other next to a vertical wall of the foundation. In a further aspect, each of the plurality of pesticidal baits disintegrates following exposure to moisture. In another aspect, each of the plurality of pesticidal baits exhibits moisture and degradation resistance.

In another embodiment, a system for controlling pests includes a plurality of freestanding pesticidal baits positioned at one or more locations of a building site. The one or more locations include at least one of one or more first positions under one or more foundation elements of a building structure and one or more second positions adjacent to the one or more foundation elements and below finish grade of the building site.

In one aspect of this embodiment, each of the plurality of pesticidal baits is defined by a compressed composite including a bait material and a pesticide. In a further aspect, each of the plurality of pesticidal baits is defined by an extruded composite including a bait material and a pesticide. In a further aspect, the pesticide is selected from the group consisting of noviflumuron, hexaflumuron, lufenuron, flufenoxuron, diflubenzuron, bistrifluron, sulfuramid, novaluron and hydramethylnon. In yet a further aspect, the bait material comprises alpha cellulose.

In still another embodiment, a method includes positioning a first pesticidal bait at a first depth below ground level proximate to a building foundation; covering the first pesticidal bait with a first portion fill material; positioning a second pesticidal bait at a second depth below the ground level proximate to a building foundation, the first depth being greater than the second depth relative to the ground level; covering the second pesticidal bait with a second portion of fill material; positioning a third pesticidal bait at a third depth below the ground level proximate to a building foundation, the second depth being greater than the third depth relative to the ground level; and covering the third pesticidal bait with a third portion of fill material. In one aspect, one or more of the first pesticidal bait, the second pesticidal bait, and the third pesticidal bait is comprised of a compressed composite including a bait material and a pesticide. In one particular aspect, the bait material is bio-degradable. In another aspect, one or more of the first pesticidal bait, the second pesticidal bait, and the third pesticidal bait is comprised of an extruded composite including a bait material and a pesticide. In a further aspect the pesticide is selected from the group consisting of noviflumuron, hexaflumuron, lufenuron, flufenoxuron, diflubenzuron, bistrifluron, sulfuramid, novaluron and hydramethylnon. In a further aspect, the bait material comprises alpha cellulose.

In a further aspect of this embodiment, the foundation includes a wall that extends vertically below the ground level, and the first pesticidal bait, the second pesticidal bait and the third pesticidal bait are positioned along the wall. In one aspect, the foundation includes a footing below the ground level and positioning the first pesticidal bait includes placement underneath the footing. In a further aspect, the method includes suspending the first pesticidal bait, the second pesticidal bait, and the third pesticidal bait in fill material. In one aspect, the method includes preparing at least a portion of the foundation after the positioning of the first pesticidal bait. In one particular aspect, each one of positioning the first pesticidal bait, positioning the second pesticidal bait, and positioning the third pesticidal bait is performed after construction of the foundation is completed to retrofit the foundation with a pesticidal barrier. In a further form, the method includes positioning a fourth pesticidal bait at a fourth depth below the ground level proximate to a building foundation, the third depth being greater than the fourth depth relative to the ground level, and covering the fourth pesticidal bait with a fourth portion of fill material.

In one aspect of this embodiment, the method includes excavating a foundation hole; establishing a first layer of fill material in the foundation hole having an upper margin below a lower terminus of the foundation; placing the first pesticidal bait on the first layer of fill material; establishing a second layer of fill material in the foundation hole to cover the first pesticidal bait, the second layer including the first portion of fill material; placing the second one of the pesticidal baits on the second layer of fill material; establishing a third layer of fill material in the foundation hole to cover the second pesticidal bait, the third layer including the second portion of fill material; placing the third one of the pesticidal baits on the third layer of fill material; and covering the third one of the pesticidal baits with a fourth layer of fill material, the fourth layer including the third portion of fill material.

In another embodiment a method includes installing at least one bait including a bait material palatable to one or more species of pest and a pesticide relative to the foundation of a building structure. The method also includes, during the installing, positioning the at least one bait at a location to lie underneath the foundation element of the building structure. In one aspect, the at least one bait is formed by a compressed mixture of the bait material and the pesticide. In a further aspect, the at least one bait is formed by an extruded mixture of the bait material and the pesticide. In another aspect, positioning the at least one bait follows excavation of the location for placement of the foundation element and precedes placement of the foundation element. In yet a further aspect, the pesticide is selected from the group consisting of noviflumuron, hexaflumuron, lufenuron, flufenoxuron, diflubenzuron, bistrifluron, sulfuramid, novaluron and hydramethylnon. In a certain aspect, the bait material comprises alpha cellulose. In one aspect, the foundation element is a concrete footing or a concrete slab. In a further aspect, the bait material comprises alpha cellulose and the pesticide comprises hexaflumuron. In one aspect, the at least one bait weighs between 1 and 50 grams. In another aspect, the at least one bait weighs between 0.1 and 10 grams. In yet another embodiment, a method includes positioning at least one bait at a location to lie underneath a foundation element of a building structure. The at least one bait includes a bait material palatable to one or more species of pest and a pesticide. In one aspect, the at least one bait is formed by a compressed mixture of the bait material and the pesticide. In a further aspect, the at least one bait is formed by an extruded mixture of the bait material and the pesticide. In another aspect, positioning the at least one bait follows excavation of the location for placement of the foundation element and precedes placement of the foundation element. In yet a further aspect, the pesticide is selected from the group consisting of noviflumuron, hexaflumuron, lufenuron, flufenoxuron, diflubenzuron, bistrifluron, sulfuramid, novaluron and hydramethylnon. In a certain aspect, the bait material comprises alpha cellulose. In one aspect, the foundation element is a concrete footing or a concrete slab. In a further aspect, the bait material comprises alpha cellulose and the pesticide comprises hexaflumuron. In one aspect, the at least one bait weighs between 1 and 50 grams. In another aspect, the at least one bait weighs between 0.1 and 10 grams.

While multiple embodiments have been illustrated and described in detail in the drawings and foregoing description, the same is to be considered illustrative and not restrictive in character, it being understood that only selected embodiments have been shown and described and that all changes, equivalents, and modifications as would occur to those skilled in the art and that come within the scope of the inventions described herein or defined by the following claims are desired to be protected. Any theory, mechanism of operation, proof, or finding stated herein is meant to further enhance understanding of the present application and is not intended to limit the inventions in any way to such theory, mechanism of operation, proof, or finding. In addition, the various procedures, techniques, and operations may be altered, rearranged, substituted, deleted, duplicated, or combined as would occur to those skilled in the art. In reading the claims, words such as the word “a,” the word “an,” the words “at least one,” and the words “at least a portion” are not intended to limit the claims to only one item unless specifically stated to the contrary. Further, when the language “at least a portion” and/or “a portion” is used, the claims may include a portion and/or the entire item unless specifically stated to the contrary.

Any reference to a specific direction, for example, references to up, upper, down, lower, and the like, is to be understood for illustrative purposes only or to better identify or distinguish various components from one another. Unless specifically identified to the contrary, all terms used herein are used to include their normal and customary terminology. Further, while various embodiments of insect control devices having specific components and structures are described and illustrated herein, it is to be understood that any selected embodiment can include one or more of the specific components and/or structures described for another embodiment where possible.

What is claimed is:

1. A method, comprising: positioning a first freestanding pesticidal bait at one or more of a first location to lie underneath a lower terminus of a building foundation and a second location below ground level and proximate to said foundation.

2. The method of claim 1, which further includes positioning a second pesticidal bait proximate to said foundation below ground level and at a depth less than said first pesticidal bait.

3. The method of claim 2, wherein said foundation is comprised of a plurality of elements and positioning said first pesticidal bait includes placement below a first one of said elements and positioning said second pesticidal bait includes placement adjacent to a second one of said elements, the second one of said elements being positioned on said first one of said elements.

4. The method of claim 2, which includes placing each of said first and second pesticidal baits below ground level and suspending each of said first and second pesticidal baits in fill.

5. The method of claim 1, wherein said first pesticidal bait is defined by a compressed composite including a bait material and a pesticide.

6. The method of claim 5, wherein said bait material is bio-degradable.

7. The method of claim 1, wherein said first pesticidal bait is defined by an extruded composite including a bait material and a pesticide.

8. The method of claim 1, wherein said first pesticidal bait includes a pesticide selected from the group consisting of noviflumuron, hexaflumuron, lufenuron, flufenoxuron, diflubenzuron, bistrifluron, sulfuramid, novaluron and hydramethylnon.

9. The method of claim 1, which includes successively placing additional ones of a plurality of pesticidal baits below ground level at a different depth relative to any other of said plurality of pesticidal baits and said first pesticidal bait.

10. A system for controlling pests, comprising a plurality of freestanding pesticidal baits positioned at one or more locations of a building site, wherein said one or more locations include at least one of one or more first positions under one or more foundation elements of a building structure and one or more second positions adjacent to said one or more foundation elements and below finish grade of said building site.

11. The system of claim 10, wherein each of said plurality of pesticidal baits includes a bait material and a pesticide, said pesticide being selected from the group consisting of noviflumuron, hexaflumuron, lufenuron, flufenoxuron, diflubenzuron, bistrifluron, sulfuramid, novaluron and hydramethylnon.

12. The system of claim 11, wherein said bait material comprises alpha cellulose.

13. The system of claim 10, wherein one or more of said plurality of freestanding pesticidal baits weighs between 1 and 50 grams.

14. The system of claim 10, wherein one or more of said plurality of freestanding pesticidal baits weighs between 0.1 and 10 grams.

15. A method, comprising:
positioning a first pesticidal bait at a first depth below ground level proximate to a building foundation;
covering the first pesticidal bait with a first portion of fill material;
positioning a second pesticidal bait at a second depth below the ground level proximate to a building foundation, the first depth being greater than the second depth relative to the ground level;
covering the second pesticidal bait with a second portion of fill material;
positioning a third pesticidal bait at a third depth below the ground level proximate to a building foundation, the second depth being greater than the third depth relative to the ground level; and
covering the third pesticidal bait with a third portion of fill material.

16. The method of claim 15, wherein one or more of the first pesticidal bait, the second pesticidal bait, and the third pesticidal bait is comprised of a compressed composite including a bait material and a pesticide, said pesticide being selected from the group consisting of noviflumuron, hexaflumuron, lufenuron, flufenoxuron, diflubenzuron, bistrifluron, sulfuramid, novaluron and hydramethylnon.

17. The method of claim 15, wherein one or more of the first pesticidal bait, the second pesticidal bait, and the third pesticidal bait is comprised of an extruded composite including a bait material and a pesticide, said pesticide being selected from the group consisting of noviflumuron, hexaflumuron, lufenuron, flufenoxuron, diflubenzuron, bistrifluron, sulfuramid, novaluron and hydramethylnon.

18. The method of claim 15, wherein each of positioning the first pesticidal bait, positioning the second pesticidal bait, and positioning the third pesticidal bait is performed after construction of the foundation is completed to retrofit the foundation with a pesticidal barrier.

19. The method of claim 15, which includes:
excavating a foundation hole;
establishing a first layer of fill material in the foundation hole having an upper margin below a lower terminus of the foundation;
placing the first pesticidal bait on the first layer of fill material;
establishing a second layer of fill material in the foundation hole to cover the first pesticidal bait, the second layer including the first portion of fill material;
placing the second one of the pesticidal baits on the second layer of till material;
establishing a third layer of fill material in the foundation hole to cover the second pesticidal bait, the third layer including the second portion of fill material;
placing the third one of the pesticidal baits on the third layer of fill material; and
covering the third one of the pesticidal baits with a fourth layer of fill material, the fourth layer including the third portion of fill material.

20. A method, comprising:
installing at least one bait including a bait material palatable to one or more species of pest and a pesticide relative to a foundation of a building structure; and
during the installing, positioning said at least one bait at a location to lie underneath an element of said foundation.

21. The method of claim 20, wherein said at least one bait is formed by one of a compressed mixture of said bait material and said pesticide and an extruded mixture of said bait material and said pesticide.

22. The method of claim 20, wherein said pesticide is selected from the group consisting of noviflumuron, hexaflumuron, lufenuron, flufenoxuron, diflubenzuron, bistrifluron, sulfuramid, novaluron and hydramethylnon.

23. The method of claim 22, wherein said bait material comprises alpha cellulose.

24. The method of claim 20, wherein said foundation element is one of a concrete footing and a concrete slab.

25. The method of claim 20, wherein said bait material comprises alpha cellulose and said pesticide comprises hexaflumuron.
